(19) United States
(12) Patent Application Publication
(10) Pub. No.: US 2014/0112635 A1
(43) Pub. Date: Apr. 24, 2014

(54) System and Method for Recording Clips of Media Content

(71) Applicant: AT&T INTELLECTUAL PROPERTY I, L.P., Atlanta, GA (US)

(72) Inventor: Sean M. Kelley, Atlanta, GA (US)

(73) Assignee: At&T Intellectual Property I, L.P., Atlanta, GA (US)

(21) Appl. No.: 13/655,208

(22) Filed: Oct. 18, 2012

(51) Int. Cl. H04N 5/775

(52) U.S. Cl. 386/230; 386/E05.07

(57) ABSTRACT

A method includes initiating playback of recorded media content and receiving a record command from a remote control device at the digital video recorder device during playback of the recorded media content, and, in response to receiving the record command, recording a portion of the media content to produce second recorded media content. The method includes receiving a stop recording command, and in response to receiving the stop recording command, stopping the recording of the media content. Playback of the recorded media content may continue after the stop recording command is received. The method includes storing the second recorded media content at a memory.

### FIELD OF THE DISCLOSURE

The present disclosure is generally related to recording media content at a digital video recorder device.

### BACKGROUND

Digital video recorder devices enable users to record media content (e.g., television programs). For example, a user may subscribe to a television service provided by a service provider such as a cable television service provider, a satellite television service provider, or an internet protocol television service provider. The user may use the digital video recorder device to record particular media content onto a memory of the digital video recorder device. The amount of memory available at the digital video recorder device may be limited. As the user records media content (e.g., television programs), the amount of available space to record additional media content is reduced, thus limiting the amount of recordings of media that the user can store at the digital video recorder device. Since a user may not be interested in all recorded content, space within the memory of the digital video recorder device may be consumed storing recorded media content that the user does not wish to view.

### BRIEF DESCRIPTION OF THE DRAWINGS

FIG. 1 is an illustrative embodiment of a system to generate a clip of recorded media content;

FIG. 2 is a first illustrative embodiment of a digital video recorder device configured to generate a clip of recorded media content;

FIG. 3 is a second illustrative embodiment of a digital video recorder device configured to generate a clip of recorded media content;

FIG. 4 is a third illustrative embodiment of a digital video recorder device configured to generate a clip of recorded media content;

FIG. 5 is an embodiment of an electronic programming guide;

FIG. 6 is an illustrative embodiment of a system including various embodiments of devices configured to generate a clip of recorded media content;

FIG. 7 is an embodiment of a method of generating a clip of recorded media content at a digital video recorder device; and

FIG. 8 is a block diagram of an illustrative embodiment of a computer system operable to support the various methods, systems, and computer readable media disclosed with respect to FIGS. 1-7.

### DETAILED DESCRIPTION

Disclosed herein are embodiments of a digital video recorder device that may enable a user of the digital video recorder device to efficiently manage recorded video content stored at a memory of the digital video recorder device. The digital video recorder device enables the user to create one or more clips of media content during playback of previously recorded media content stored at the memory of the digital video recorder device. For example, a user may record a program (e.g., a television program) and initiate playback of the recorded program. During the playback of the recorded program, the user may enjoy a particular portion (e.g., a scene) of the recorded program. The user may wish to save the particular portion of the recorded program for future viewing without storing or retaining the remaining portions of the recorded program. The user may press a record button on a remote control device at the beginning of the particular portion to initiate recording of a clip and may press the record button a second time during the playback of the recorded media content to designate an end of the clip. The particular portion of the media content that was played back between the user pressing the record button the first time and pressing the record button the second time may be stored as a clip at the digital video recorder device. After recording the clip, the recorded program may be deleted from the memory of the digital video recorder device while the clip (i.e., the particular portion of the recorded program) is maintained in the memory of the digital video recorder device for future viewing by the user. The clip consumes less storage space (i.e., space in the memory) than the recorded program. Thus, the user may save portions of recorded media content (i.e., clips) that are of interest to the user at the digital video recorder device while freeing previously used storage space at the memory of the digital video recorder device for reuse.

Systems and methods to record clips of media content are disclosed. In a particular embodiment, a method includes initiating playback of recorded media content at a digital video recorder device. The method includes receiving a record command from a remote control device at the digital video recorder device during playback of the recorded media content, and, in response to receiving the record command, recording a portion of the media content to produce second recorded media content. The method includes receiving a stop recording command at the digital video recorder device, and, in response to receiving the stop recording command, stopping the recording of the media content. Playback of the recorded media content may continue after the stop recording command is received. The method includes storing the second recorded media content at a memory of the digital video recorder device.

In another embodiment, a system includes a processor and a memory. The memory may store instructions that, when executed by the processor, cause the processor to perform a method. The method includes initiating playback of recorded media content at a digital video recorder device. The method includes receiving a record command from a remote control device at the digital video recorder device during playback of the recorded media content, and, in response to receiving the record command, recording a portion of the media content to produce second recorded media content. The method includes receiving a stop recording command at the digital video recorder device, and, in response to receiving the stop recording command, stopping the recording of the media content. Playback of the recorded media content may continue after the stop recording command is received. The method includes storing the second recorded media content at a memory of the digital video recorder device.

In another embodiment, a computer-readable storage is disclosed. The computer-readable storage may include instructions that, when executed by a processor, cause the processor to perform a method. The method includes initiating playback of recorded media content at an electronic device. Playback of the recorded media content may include displaying the recorded media content at a display device communicatively coupled a processor of the electronic device. The method includes receiving a record command at the electronic device during playback of the recorded media content, and, in response to receiving the record command, initiating a recording of a portion of the media content to produce second recorded media content. The method includes receiving a stop recording command at the electronic device and, in response to receiving the stop recording command, stopping the recording of the media content. Playback of the recorded media content may continue after the stop recording command is received. The second recorded media content may be stored at a memory of a digital video recorder device accessible to the electronic device.

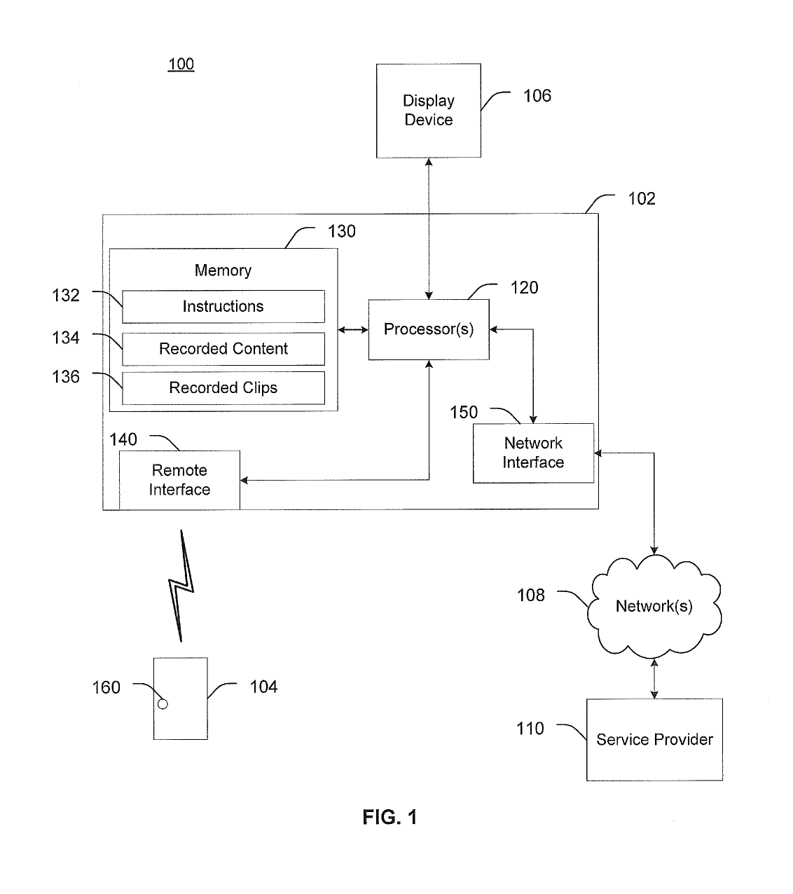

Referring to FIG. 1, a system to generate a clip of recorded media content is shown and designated 100. As shown in FIG. 1, the system 100 includes a digital video recorder device 102. The digital video recorder device 102 may include a processor(s) 120, a memory 130, a remote interface 140, and a network interface 150. It should be understood that the memory 130 may include volatile memory (e.g., static random access memory (SRAM), dynamic random access memory (DRAM), etc.) and non-volatile memory (e.g., read only memory (ROM), flash memory, hard disk drives, etc.). The processor(s) 120 may communicate with a network(s) 108 via the network interface 150. A service provider 110 may be coupled to the network(s) 108 and may transmit media content (e.g., television programs) to the digital video recorder device 102 via the network(s) 108. The media content may be received at the digital video recorder device 102 via the network interface 150 and provided to the processor(s) 120. The digital video recorder device 102 may be coupled to a display device 106 (e.g., a television) and the processor(s) 120 may be configured to provide the media content received from the service provider 110 to the display device 106 for display.

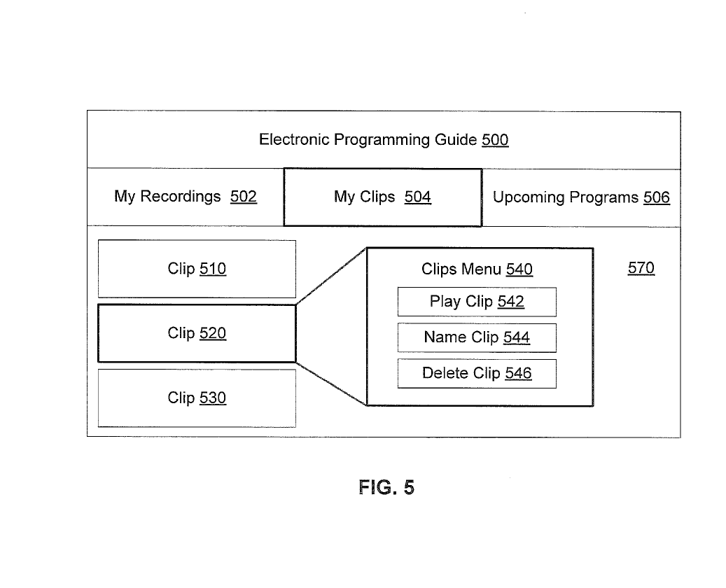

A user associated with the digital video recorder device 102 may use a remote control device 104 to interact with the digital video recorder device 102. For example, the user may be a subscriber to a television service provided by the service provider 110. In an embodiment, the television service may be a cable television service, a satellite television service, an internet protocol television service, or a combination of these services. The television service may provide one or more channels of media content (e.g., television programs) to the digital video recorder device 102. The user may use the remote control device to change channels, to access interactive content provided via the one or more channels, and to record media content (e.g., television programs) provided via the one or more channels. Methods of recording media content (e.g., television programs) are described with reference to FIG. 5.

As shown in FIG. 1, the memory 130 may store instructions 132, recorded content 134, and recorded clips 136. The recorded content 134 may correspond to recordings of media content (e.g., television programs) received from the service provider 110, as described with reference to FIG. 5. The recorded clips may correspond to recordings of portions of recorded content 134 generated during playback of the recorded content 134. In a particular embodiment, the recorded content 134 may be differentiated from the recorded clips 136 using metadata. For example, recorded content 134 may be stored with metadata indicating that the recorded content 134 is a recording of media content received from the service provider 110, rather than a recording of recorded content (e.g., a clip). Similarly, the recorded clips 136 may be stored with metadata indicating that the recorded clips 136 are recordings of recorded content 134. The metadata may be used to present the recorded content 134 and the recorded clips 136 at an electronic program guide as described with reference to FIG. 5. The instructions 132 may store instructions executable by the processor(s) 120 to implement the various methods and embodiment described with reference to FIGS. 1-6.

In a particular embodiment, during operation, the digital video recorder device 102 may initiate playback of the recorded content 134. For example, the digital video recorder device 102 may receive a request to playback particular recorded content 134 from the remote control device 104. In a particular embodiment, the request to playback the particular recorded content 134 may be generated based on user interaction with an electronic program guide, such as the electronic program guide described with reference to FIG. 5. In response to receiving the request to playback the particular recorded content 134, the digital video recorder device 102 may cause the particular recorded content 134 to be displayed at the display device 106.

During playback of the particular recorded content, the digital video recorder device 102 may receive a record command from the remote control device 104. In a particular embodiment, the remote control device may transmit the record command to the digital video recorder device 102 in response to the user pressing a record button 160 on the remote control device 104. In response to receiving the record command from the remote control device during playback of the particular recorded content 134, the digital video recorder device 102 may initiate recording of at least a portion of the particular recorded content 134 to produce second recorded content (e.g., a clip of the particular recorded content 134). The digital video recorder device 102 may store the second recorded content at the memory 130 of the digital video recorder device 102 as a recorded clip 136.

In another embodiment, the digital video recorder device 102 may initiate recording of at least a portion of the particular recorded content 134 in response to receiving the record command from the remote control device 104 during playback of the particular recorded content 134. During the playback of the recorded media content, the digital video recorder device 102 may receive a stop recording command. In a particular embodiment, the remote control device may transmit the stop recording command to the digital video recorder device 102 in response to the user pressing the record button 160 on the remote control device 104 a second time.

In response to receiving the stop recording command, the digital video recorder device 102 may stop the recording of the particular media content 134 may store the second recorded content at the memory 130 of the digital video recorder device 102 as the recorded clip 136. In an embodiment, playback of the particular recorded content 134 continues after the stop recording command is received. In this embodiment, the record command may be received at a first time during the playback of the particular recorded content 134 and the stop recording command may be received at a second time during playback of the particular recorded content 134. The second recorded content (e.g., the recorded clip 136) may include media content corresponding to a portion of the particular recorded content 134 that was displayed at the display device 106 between the first time and the second time. The second recorded content (e.g., the recorded clip 136) may not include a first portion of the particular recorded content 134 that was displayed at the display device 106 prior to the first time and may not include a second portion of the particular recorded content 134 that was displayed at the display device 106 after to the second time.

Subsequent to storing the second recorded content as the recorded clip 136, the digital video recorder device 102 may receive a request to playback the recorded clip 136. In response to receiving the request to playback the recorded clip 136, the digital video recorder device 102 may initiate playback of the recorded clip 136 at the display device 106. Embodiments of methods and interfaces that may be used by the digital video recorder device 102 to playback the recorded clip 136 are described with reference to FIG. 5.

After generating the recorded clip 136, the user may delete the particular recorded content 134 from the memory 130 of the digital video recorder device 102 while retaining a portion of the particular recorded content 134 (e.g., the recorded clip 136) that the user may wish to view again. Thus, by creating clips of recorded content and then deleting the recorded content, additional storage space may be created at the memory 130. The additional storage space may be used for recording additional content (e.g., television programs) and/or additional clips of recorded content.

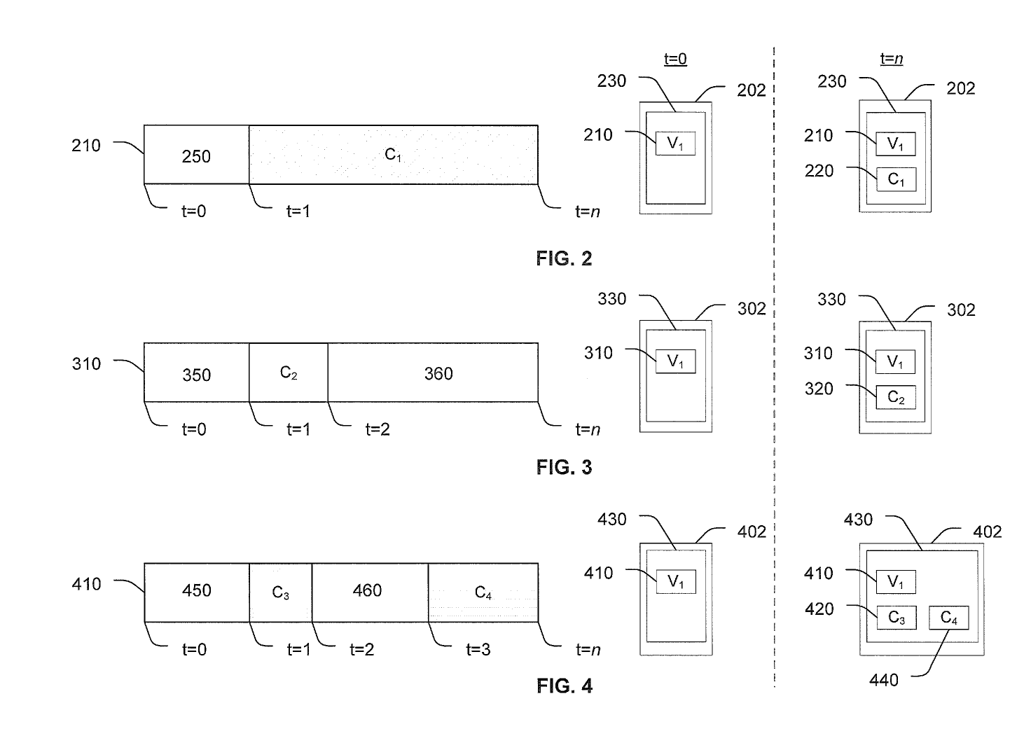

Referring to FIG. 2, a first illustrative embodiment of a digital video recorder device 202 configured to generate a clip of recorded media content is shown. As shown in FIG. 2, at a time t=0, a memory 230 of the digital video recorder device 202 may store a recorded program (V₁) as recorded content 210. At time t=0, the digital video recorder device 202 may receive an initiate playback command to playback the recorded content 210. In response to receiving the initiate playback command, the digital video recorder device 202 may cause the recorded content 210 to be displayed at a display device (not shown). At a time t=1, the digital video recorder device 202 may receive a record command to record a clip (C₁) of the recorded content 210. In response to receiving the record command, the digital video recorder device 202 may initiate recording of a clip (C₁) of the recorded content 210.

At a time t=n, playback of the recorded media content may end and the digital video recorder device 202 may store the clip (C₁) at the memory 230 of the digital video recorder device 202. For example, as shown in FIG. 2, at time t=n, the clip (C₁) is stored as clip 220 at the memory 230 of the digital video recorder device 202. In a particular embodiment, the digital video recorder device 202 may be the digital video recorder device 102 described with reference to FIG. 1. In a particular embodiment, time t=n corresponds to an end of the playback of the recorded content 210. For example, playback of the recorded content 210 may continue until an end of the recorded program (V₁) has been reached and the entire recorded video content 210 has been displayed. In another embodiment, time t=n corresponds to a time when a stop playback command is received. For example, the stop playback command may be received at the digital video recorder device 202 from a remote control device (e.g., the remote control device 104). The remote control device may transmit the stop playback command to the digital video recorder device 202 in response to a user pressing a button on the remote control device (e.g., a stop button or a record button).

The clip 220 may take up a smaller amount of storage space at the memory 230 than the recorded content 210. For example, the clip 220 may include the portion (C₁) of the recorded content 210 and may not include the portion 250 of the recorded content 210. After generating the clip 220, the user may delete the recorded content 210 from the memory 230 of the digital video recorder device 202 while retaining a portion of the recorded content 210 (e.g., the clip 220) that the user may wish to view again. Thus, by creating clips of recorded content and then deleting the recorded content, additional storage space may be created at the memory 230. The additional storage space may be used for recording additional programs (e.g., television shows) and/or additional clips of recorded content.

Referring to FIG. 3, a second illustrative embodiment of a digital video recorder device 302 configured to generate a clip of recorded media content is shown. As shown in FIG. 3, at a time t=0, a memory 330 of the digital video recorder device 302 may store a recorded program (V₁) as recorded content 310. At time t=0, the digital video recorder device 302 may receive an initiate playback command to playback the recorded content 310. In response to receiving the initiate playback command, the digital video recorder device 302 may cause the recorded content 310 to be displayed at a display device (not shown). At a time t=1, the digital video recorder device 302 may receive a record command to record a clip (C₂) of the recorded content 310. In response to receiving the record command, the digital video recorder device 302 may initiate recording of a clip (C₂) of the recorded content 310. In a particular embodiment, the record command may be received at the digital video recorder device 302 from a remote control device (e.g., the remote control device 104). The remote control device may transmit the record command to the digital video recorder device 302 in response to a user pressing a record button (e.g., the record button 160) on the remote control device.

At a time t=2, the digital video recorder device 302 may receive a stop recording command. In a particular embodiment, the stop recording command may be received at the digital video recorder device 302 from the remote control device. The remote control device may transmit the stop recording command to the digital video recorder device 302 in response to the user pressing the record button on the remote control device. In response to receiving the stop recording command, the digital video recorder device may stop recording the clip (C₂) and may store the clip (C₂) at the memory 330 as clip 320.

Playback of the recorded content 310 may continue until a time t=n when playback of the recorded content 310 ends. For example, as shown in FIG. 2, when time t=n, the clip (C₁) is stored as clip 320 at the memory 330 of the digital video recorder device 302. In a particular embodiment, the digital video recorder device 302 may be the digital video recorder device 102 described with reference to FIG. 1. In a particular embodiment, time t=n corresponds to an end of the playback of the recorded content 310. For example, playback of the recorded content 310 may continue until an end of the recorded program (V₁) has been reached and the entire recorded content 310 has been displayed. In another embodiment, time t=n corresponds to a time when a stop playback command is received. For example, the stop playback command may be received at the digital video recorder device 302 from a remote control device (e.g., the remote control device 104). The remote control device may transmit the stop playback command to the digital video recorder device in response to a user pressing a button on the remote control device (e.g., a stop button or a record button).

The clip 320 may take up a smaller amount of storage space at the memory 330 than the recorded content 310. For example, the clip 320 may include the portion (C₂) of the recorded content 310 and may not include the portions 350, 360 of the recorded content 310. After generating the clip 320, the user may delete the recorded content 310 from the memory 330 of the digital video recorder device 302 while retaining a portion of the recorded content 310 (e.g., the clip 320) that the user may wish to view again. Thus, by creating clips of recorded content and then deleting the recorded content, additional storage space may be created at the memory 330. The additional storage space may be used for recording additional programs (e.g., television shows) and/or additional clips of recorded content.

Referring to FIG. 4, a third illustrative embodiment of a digital video recorder device 402 configured to generate a clip of recorded media content is shown. As shown in FIG. 4, at a time t=0, a memory 430 of the digital video recorder device 402 may store a recorded program (V₁) as recorded content 410. At time t=0, the digital video recorder device 402 may receive an initiate playback command to playback the recorded content 410. In response to receiving the initiate playback command, the digital video recorder device 402 may cause the recorded content 410 to be displayed at a display device (not shown). At a time t=1, the digital video recorder device 402 may receive a record command to record a clip (C₃) of the recorded content 410. In response to receiving the record command, the digital video recorder device 402 may initiate recording of a clip (C₃) 420 of the recorded content 410. In a particular embodiment, the record command may be received at the digital video recorder device 402 from a remote control device (e.g., the remote control device 104). The remote control device may transmit the record command to the digital video recorder device 402 in response to a user pressing a record button (e.g., the record button 160) on the remote control device.

At a time t=2, the digital video recorder device 402 may receive a stop recording command. In a particular embodiment, the stop recording command may be received at the digital video recorder device 402 from the remote control device. The remote control device may transmit the stop recording command to the digital video recorder device 402 in response to the user pressing the record button on the remote control device. In response to receiving the stop recording command, the digital video recorder device may stop recording the clip (C₃) and may store the clip (C₃) at the memory 430 as clip 420.

At a time t=3, the digital video recorder device 402 may receive a record command to record a second clip (C₄) of the recorded content 410. In response to receiving the record command, the digital video recorder device 402 may initiate recording of a clip (C₄) of the recorded content 410. In a particular embodiment, the record command may be received at the digital video recorder device 402 from a remote control device. The remote control device may transmit the record command to the digital video recorder device 402 in response to the user pressing the record button on the remote control device.

At a time t=n, playback of the recorded media content may end and the digital video recorder device 402 may store the clip (C₄) at the memory 430. For example, as shown in FIG. 4, at time t=n, the clip (C₃) and the clip (C₄) are stored as clips 420 and 440, respectively, at the memory 430. In a particular embodiment, time t=n corresponds to an end of the playback of the recorded content 410. For example, playback of the recorded content 410 may continue until an end of the recorded program (V₁) has been reached and the entire recorded content 410 has been displayed. In another embodiment, time t=n corresponds to a time when a stop playback command is received. For example, the stop playback command may be received at the digital video recorder device 402 from a remote control device (e.g., the remote control device 104). The remote control device may transmit the stop playback command to the digital video recorder device in response to a user pressing a button on the remote control device (e.g., a stop button or a record button).

The clips 420, 440 take up a smaller amount of storage space at the memory 430 than the recorded content 410. For example, the clip 420 may include the portion (C₃) of the recorded content 410 and may not include the portions 450, 460, (C₄) of the recorded content 410. Additionally, the clip 440 may include the portion (C₄) of the recorded content 410 and may not include the portions 450, (C₃), 460 of the recorded content 410. After generating the clips 420, 440, the user may delete the recorded content 410 from the memory 430 of the digital video recorder device 402 while retaining portions of the recorded content 410 (e.g., the clips 420, 440) that the user may wish to view again. Thus, by creating clips of recorded content and then deleting the recorded content, additional storage space may be created at the memory 430. The additional storage space may be used for recording additional programs (e.g., television shows) and/or additional clips of recorded content.

Referring to FIG. 5, an embodiment of an electronic programming guide 500 is shown. As shown in FIG. 5, the electronic programming guide 500 includes a My Recordings tab 502, a My Clips tab 504, an Upcoming Programs tab 506, and a display area 570. The electronic programming guide 500 may be generated by a digital video recorder device (e.g., the digital video recorder device 102) and presented at a display device (e.g., the display device 106) that is coupled to the digital video recorder device.

A user may interact with the electronic programming guide 500 using a remote control device (e.g., the remote control device 104) and select the Upcoming Programs tab 506. In response to the selection of the Upcoming Programs tab 506, the display area 570 may display a list of media programming to be received at the digital video recorder device during a time period (e.g., the next two hours). For example, the user may subscribe to a television service provided by a service provider (e.g., the service provider 110). The service provider may provide a plurality of media channels to the digital video recorder device via a network (e.g., the network(s) 108). Each of the plurality of channels may be associated with different media content (e.g., television programs). The user may view interact with the display area 570 using the remote control device and schedule a recording of particular media content. After scheduling the recording of the particular media content, the digital video recorder device may record the particular media content and store the recording of the particular media content at the memory (e.g., the memory 130) of the digital video recorder.

The user may interact with the electronic programming guide 500 using a remote control device and select the My Recordings tab 502 to view a list of recordings. The list of recordings may be displayed in the display area 570 and may include recordings of the media content transmitted by the service provider. For example, when the user schedules a recording of particular media content using the Upcoming Programs tab 506, the digital video recorder may record the particular media content and store the recording as recorded content (e.g., the recorded content 134) at a memory of the digital video recorder device.

The user may interact with the electronic programming guide 500 using a remote control device and select the My Clips tab 504 to view a list of clips. The list of clips may be displayed in the display area 570. As shown in FIG. 5, a list of clips is shown in the display area 570 and includes a Clip 510, a Clip 520, and a Clip 530. Each of the Clips 510-530 may be generated during playback of previously recorded media content as described with reference to FIGS. 1-4. As shown in FIG. 5, the Clip 520 has been selected. In response to the selection of the Clip 520, a Clips Menu 540 is displayed in the display area 570. The Clips Menu 540 may include a Play Clip option 542, a Name Clip option 544, and a Delete Clip option 546. The user may initiate playback of the Clip 520 by selecting the Play Clip option 542. The user may edit a name of the Clip 520 by selecting the Name Clip option 544. The user may delete the Clip 520 by selecting the Delete Clip option 546.

To illustrate, a user may schedule a recording of a program to be broadcast or otherwise transmitted by the service provider on a particular channel using the Upcoming Programs tab 506 of the electronic programming guide 500. At a scheduled start time of the program, the digital video recorder device (e.g., the digital video recorder device 102) may begin recording the program. After recording the program, the digital video recorder may store the program at a memory (e.g., the memory 130) of the digital video recorder. Subsequently, the user may access the recording of the program using the My Recordings tab 502. For example, the user may interact with electronic program guide 500 and select the My Recordings tab 502. In response to the selection of the My Recordings tab 502, the digital video recorder device may display the list of recordings, including the recorded program, at the display area 570. The user may select the recorded program. In a particular embodiment, when a recorded program is selected from the list of recordings, a menu (not shown) similar to the Clips Menu 540 may be presented and may include an option to play the recorded program, an option to name the recorded program, and an option to delete the recorded program.

The user may initiate playback of the recorded program from the My Recordings tab 502. The digital video recorder device (e.g., the digital video recorder device 102) may initiate playback of the recorded program at a display device (e.g., the display device 106). During playback of the recorded program, a user may desire to record a clip of a portion of the recorded program. For example, the recorded program may be an award show and the user may enjoy a particular musical performance performed during the award show. The user may rewind the award show to the beginning of the musical performance, or to a point prior the musical performance, and press a record button (e.g., the record button 160) on the remote control device (e.g., the remote control device 104). In response to the user pressing the record button, the remote control device may transmit a record command to the digital video recorder device. In response to receiving the record command during playback of the recorded media content, the digital video recorder device may initiate recording of a clip of the recorded media content (e.g., a clip of the musical performance). The digital video recorder device may continue recording the clip of the recorded program until a stop recording command is received or until the playback of the recorded content ends. In a particular embodiment, the stop recording command may be transmitted to the digital video recorder device by the remote control device in response to the user pressing the record button a second time. In a particular embodiment, playback of the recorded content may continue after the stop recording command is received at the digital video recorder device.

After recording the clip of the recorded program, the digital video recorder device may store the clip at the memory of the digital video recorder device. The clip may be stored using a default name (e.g., the name of the recorded program as previously identified in the Upcoming Programs tab 506). The user may interact with the electronic program guide 500 and select the My Clips tab 504. In response to selecting the My Clips tab 504, the digital video recorder device may present the list of clips, including the clip of the musical performance, at the display area 570. The user may select the clip of the musical performance using the remote control device. In response to the selection, the Clips Menu 540 may be displayed. The user may rename the clip by selecting the Name Clip option 544. For example, the user may name the clip to indicate the name and/or title of the song(s) performed during the musical performance, or otherwise give the clip a name that will enable the user to easily identify the clips content. In a particular embodiment, a user interface (not shown) may be provided in response to selecting the Name Clip option 544. The user interface may enable the user to provide information indicating the desired name of the clip to the digital video recorder device.

The user may initiate playback of the clip of the musical performance by selecting the Play Clip option 542 from the Clips Menu 540. In a particular embodiment, during playback of the clip of the musical performance, the user may make a first selection of the record button to initiate recording of a clip (i.e., a clip of a clip) and may make a second selection of the record button to stop recording of the clip. The clip recorded during playback of the clip of the musical performance may be stored at the digital video recorder device 102 as an additional recorded clip 136. Additionally, the user may delete the clip of the musical performance by selecting the Delete Clip option 546. Additionally, the user may perform similar actions with respect to the recorded program from the My Recordings tab 502. For example, the user may initiate playback of the recorded content, edit a name of the recorded content, or delete the recorded content.

In a particular embodiment, the electronic program guide 500 populates the lists of media content (e.g., recordings and clips) displayed in response to selection of the My Recordings option 502 and the My Clips option 504 based on metadata (e.g., the metadata described with reference to FIG. 1) associated with a particular recording. For example, when the metadata indicates the particular recording is a clip, the particular recording is displayed in the list of clips when the My Clips option 504 is selected and is not displayed in the list of recordings when the My Recordings option 502 is selected. Similarly, when the metadata indicates the particular recording is a recorded content (i.e., not a clip), the particular recording is displayed in the list of recordings when the My Recordings option 502 is selected and is not displayed in the list of clips when the My Clips option 504 is selected.

Thus, the electronic program guide 500 provides a simple interface that a user can interact with to schedule recordings, to generate clips of recorded programs, and to manage both recorded content and clips stored at the digital video recorder device. By enabling the user to generating clips of recorded programs, the user may save portions of recorded programs (i.e., clips) that the user may wish to view again. After generating the clip, the user may delete the recorded program, freeing additional storage space at the memory of the digital video recorder device while retaining the portions of the recorded program (i.e., the clip) that the user wishes to view again.

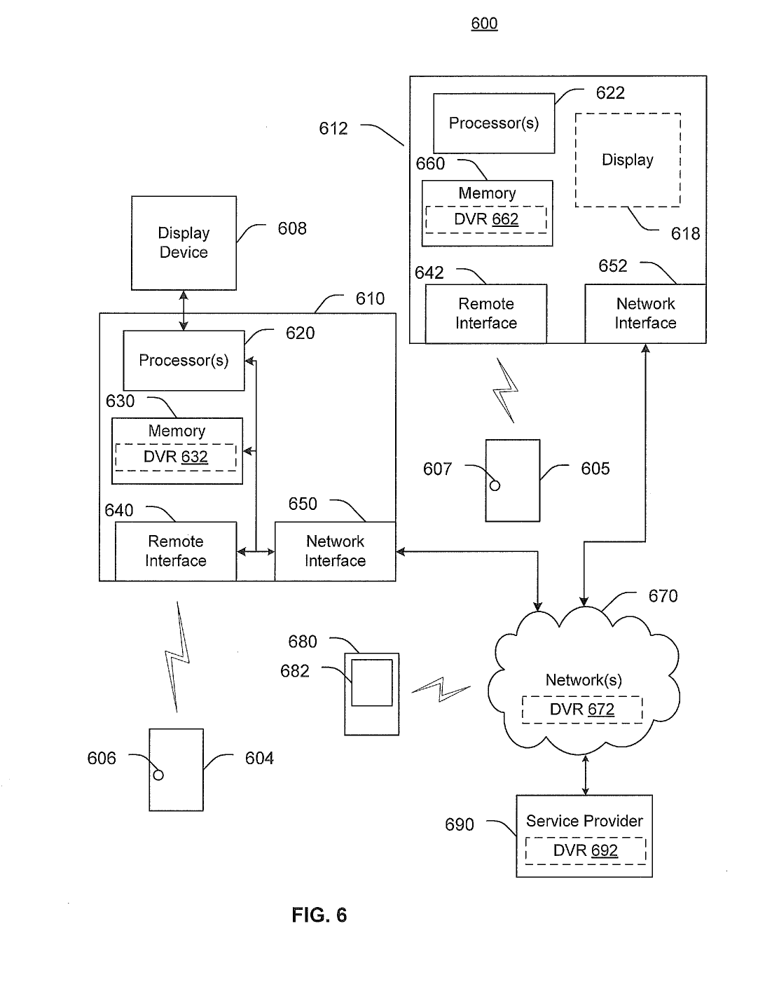

Referring to FIG. 6, an illustrative embodiment of a system 600 including various embodiments of devices configured to generate a clip of recorded media content is shown. As shown in FIG. 6, the system 600 includes a set top box device 610, a portable electronic device 680, and a display device 612.

As shown in FIG. 6, the set top box device 610 may include a processor(s) 620, a memory 630, a remote interface 640, and a network interface 650. The processor(s) 620 may communicate with a network(s) 670 via the network interface 650. A service provider 690 may be coupled to, or operate, the network(s) 670 and may transmit media content (e.g., television programs) to the set top box device 610 via the network(s) 670. The media content may be received at the set top box device 610 via the network interface 650 and may be provided to the processor(s) 620. The set top box device 610 may be coupled to a display device 608 (e.g., a television) and the processor(s) 620 may be configured to provide the media content received from the service provider 690 to the display device 608 for display. The remote interface 640 may communicate with a remote control device 604 to enable a user to interact with the set top box device 610.

In a particular embodiment, the memory 630 stores instructions, such as the instructions 132 described with reference to FIG. 1, that enable the set top box device 610 to perform one or more of the functions (e.g., recording clips) and/or provide one or more of the features (e.g., the electronic programming guide 500) of the digital video recorder device 102. For example, the memory 630 may store digital video recorder instructions 632 that enable the set top box device 610 to record and store media content (e.g., the recorded content 134 and the recorded clips 136) at the memory 630.

Alternatively, or in addition, the memory 630 may store instructions that enable the set top box 610 to initiate recording of media programs (e.g., television shows) at a network digital video recorder, such as the network digital video recorder device 672 or the network digital video recorder device 692. To illustrate, a user may use an electronic programming guide (e.g., the electronic programming guide 500) to schedule a recording of a media program (e.g., a television program) by interacting with the set top box device 610 using the remote control device 604. The processor(s) 620 may cause signals to be transmitted to a server (not shown) or other device coupled to the network 670 to schedule or initiate the recording of the media program. The recording of the media program may be stored at the network digital video recorder device 672.

Subsequently, the user may use the remote control device 604 to interact with the electronic programming guide to request playback of the recorded media program from the network digital video recorder device 672. A server or other device coupled to the network 670 may receive a signal from the set top box device 610 and cause the recorded program to be streamed or otherwise transmitted to the set top box device 610 for playback at the display device 608. During the playback of the recorded program, a user may select a record button 606 on the remote control device 604 to initiate recording of a clip of the recorded program. The remote control device 604 may transmit a record command to the set top box device 610 via the remote interface 640. The remote interface 640 may provide the record command to the processor(s) 620 and, in response, the processor(s) 620 may transmit the record command to the server or other device coupled to the network 670 via the network interface 650.

In response to receiving the record command from the set top box device 610, the server or other device may initiate recording of a portion of the recorded program (e.g., a clip). Similarly, the set top box device 610 may receive a stop recording command at the remote interface 640 from the remote control device 604 in response to a second selection of the record button 606. The processor(s) 620 may receive the stop recording command from the remote interface 640 and, in response, the processor(s) 620 may transmit the stop recording command to the server or other device coupled to the network 670 via the network interface 650. In response to receiving the stop recording command, the server or other device may stop recording the portion of the recorded program. In a particular embodiment, after the stop recording command is received, the server or other device coupled to the network 670 may continue to provide (e.g., continue streaming) the recorded program to the set top box device 610 for playback at the display device 608. The portion of the recorded program (e.g., the clip) may be stored at the digital video recorder device 672. The user may use the remote control device 604 to interact with the electronic program guide to initiate playback of the clip from the network digital video recorder device 672, as described with reference to FIG. 5.

As shown in FIG. 6, the device 612 may be an integrated electronic device that includes a processor(s) 622, a memory 660, a remote interface 642, a network interface 652, and a display 618. In a particular embodiment, the display device 612 may be a television set and the display 618 may be a television screen incorporated into the television set.

The processor(s) 622 may communicate with the network(s) 670 via the network interface 652. The service provider 690 may be coupled to, or operate, the network(s) 670 and may transmit media content (e.g., television programs) to the display 618 via the network(s) 670. The media content may be received at the display 618 via the network interface 650 and provided to the processor(s) 620. The processor(s) 622 may be configured to present the media content received from the service provider 690 to the display 618. The remote interface 642 may communicate with a remote control device 605 to enable a user to interact with the display device 612.

In a particular embodiment, the memory 662 may store instructions, such as the instructions 132 described with reference to FIG. 1, that enable one or more of the functions (e.g., recording clips) and/or provide one or more of the features (e.g., the electronic programming guide 500) of the digital video recorder device 102. For example, the memory 660 may store digital video recorder instructions 662 that enable storage of media content (e.g., the recorded content 134 and the recorded clips 136) at the memory 660.

Alternatively, or in addition, the memory 660 may store instructions that enable the device 612 to initiate recording of media programs (e.g., television shows) at the network digital video recorder 672 or the network digital video recorder device 692. To illustrate, a user may use an electronic programming guide (e.g., the electronic programming guide 500) to schedule a recording of a media program (e.g., a television program) by interacting with the device 612 using the remote control device 605. The processor(s) 622 may cause signals to be transmitted from the network interface 652 to a server (not shown) or other device coupled to the network 670 to schedule or initiate the recording of the media program. The recording of the media program may be stored at the digital video recorder device 672.

Subsequently, the user may use the remote control device 605 to interact with the electronic programming guide to request playback of the recorded media program from the network digital video recorder device 672. The server or other device coupled to the network 670 may receive a playback signal from the device 612 and cause the recorded program to be streamed or otherwise transmitted to the device 612 for playback at the display 618. During the playback of the recorded program, the user may select a record button 607 on the remote control device 605 to initiate recording of a clip of the recorded program. The remote control device 605 may transmit a record command to the device 612 via the remote interface 642. The remote interface 642 may provide the record command to the processor(s) 622 and, in response, the processor(s) 622 may transmit the record command to the server or other device coupled to the network 670 via the network interface 652.

In response to receiving the record command from the device 612, the server or other device may initiate recording of a portion of the recorded program (e.g., a clip). Similarly, the device 612 may receive a stop recording command at the remote interface 642 from the remote control device 605 in response to a second selection of the record button 607. The processor(s) 622 may receive the stop recording command from the remote interface 642 and, in response, the processor(s) 622 may transmit the stop recording command to the server or other device coupled to the network 670 via the network interface 652. In response to receiving the stop recording command, the server or other device may stop recording the portion of the recorded program. In a particular embodiment, after the stop recording command is received, the server or other device coupled to the network 670 may continue to provide (e.g., continue streaming) the recorded program to the device 612 for playback at the display 618. The portion of the recorded program (e.g., the clip) may be stored at the digital video recorder device 672. The user may use the remote control device 605 to interact with the electronic program guide to initiate playback of the clip from the digital video recorder device 672, as described with reference to FIG. 5.

As shown in FIG. 6, the portable electronic device 680 includes a display 682. In an embodiment, the display 682 is a touch screen display and the portable electronic device may receive input via the display 682 (e.g., when a user touches a control on the screen). In an embodiment, the portable electronic device 680 is a cell phone, a smart phone, a personal digital assistant (PDA), a tablet, a laptop, or other electronic device capable of receiving data via a network.

The portable electronic device 680 includes a processor (not shown) and a wireless network interface (not shown). The wireless network interface may enable the processor to communicate with the network(s) 670. In a particular embodiment, the network(s) 670 may be accessible to the portable electronic device 680 via the wireless network interface. For example, the network(s) 670 may include, or may otherwise be accessible via a cellular data network and/or a wi-fi wireless network. The service provider 690 may transmit media content (e.g., television programs) to the portable electronic device 680 via the network(s) 670. The media content may be received at the portable electronic device 680 via the wireless network interface and presented at the display 682. The user may interact with the portable electronic device 680 via the display 682 (e.g., a touch screen) or other controls (e.g., buttons) of the portable electronic device 680.

In a particular embodiment, the portable electronic device 680 includes a memory (not shown) storing instructions that enable the portable electronic device 680 to initiate recording of media programs (e.g., television shows) at the network digital video recorder 672. To illustrate, the user may use an electronic programming guide (e.g., the electronic programming guide 500) presented at the display 682 to schedule a recording of a media program (e.g., a television program) by interacting with the portable electronic device 680 using a touch screen or other controls (e.g., buttons). The processor (not shown) of the portable electronic device 680 may cause signals to be transmitted from the wireless network interface to a server (not shown) or other device coupled to the network 670 to schedule or initiate the recording of the media program at a network digital video recorder device, such as the network digital video recorder device 672 or the network digital video recorder device 692. The recording of the media program may be stored as recorded content at the digital video recorder device.

Subsequently, the user may use the touch screen or other controls to interact with the electronic programming guide to request playback of the recorded media program from the digital video recorder device 672. The server or other device coupled to the network 670 may receive a signal from the portable electronic device 680 and cause the recorded program to be streamed or otherwise transmitted to the portable electronic device 680 for playback at the display 682. During the playback of the recorded program, the user may select a record button (not shown) on the portable electronic device 680 to initiate recording of a clip of the recorded program. In a particular embodiment, the record button may be presented at the display 682 as an overlay concurrently with the display of the recorded program. In another embodiment, the record button (not shown) may correspond to a particular button (e.g., a star (*) button) on the portable electronic device 680. The processor(s) 622 may detect the selection of the record button and, in response, the processor(s) 622 may transmit the record command to the server or other device coupled to the network 670 via the wireless network interface.

In response to receiving the record command from the portable electronic device 680, the server or other device may initiate recording of a portion (e.g., a clip) of the recorded program. Similarly, the portable electronic device 680 may receive a stop recording command in response to a second selection of the record button. The processor of the portable electronic device 680 may detect the second selection of the record button and, in response, the processor may transmit a stop recording command to the server or other device coupled to the network 670 via the wireless network interface. In response to receiving the stop recording command, the server or other device may stop recording the portion of the recorded program. In a particular embodiment, after the stop recording command is received, the server or other device coupled to the network 670 may continue to provide (e.g., continue streaming) the recorded program to the portable electronic device 680 for playback at the display 682. The portion of the recorded program (i.e., the clip) may be stored at the digital video recorder device 672. The user may use the touch screen or other controls to interact with the electronic program guide to initiate playback of the clip from the digital video recorder device 672, as described with reference to FIG. 5.

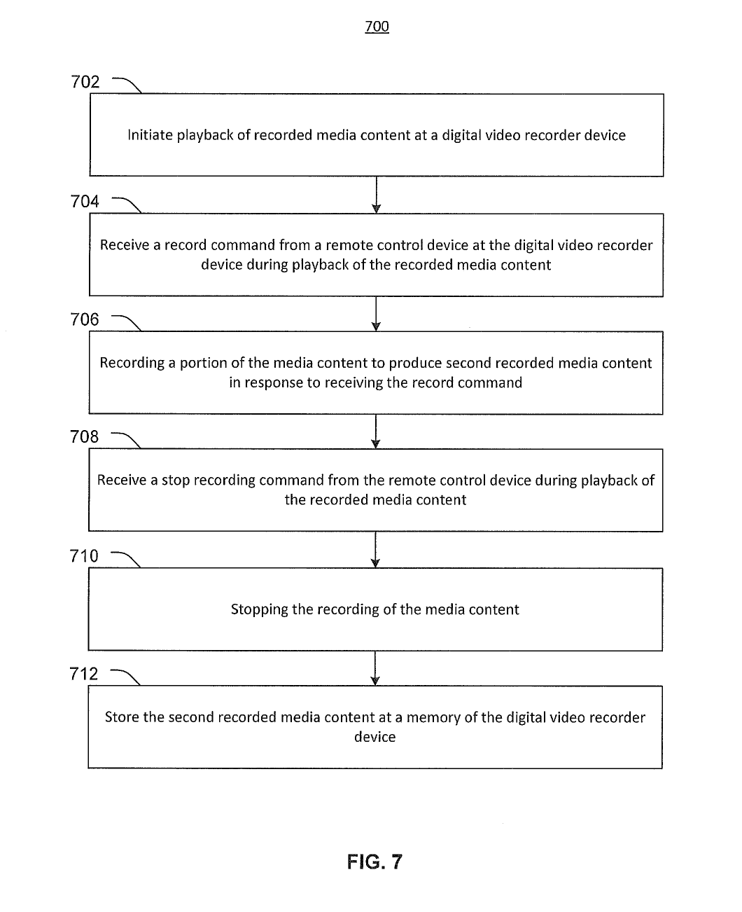

Referring to FIG. 7, a method of generating a clip of recorded media content at a digital video recorder device is shown and designated 700. At 702, the method 700 includes initiating playback of recorded media content at a digital video recorder device (e.g., the digital video recorder device 102). Playback of the recorded media content may include displaying the recorded media content at a display device coupled to the digital video recorder device. The method 700 includes, at 704, receiving a record command from a remote control device (e.g., the remote control device 104) at the digital video recorder device during playback of the recorded media content, and, at 706, recording a portion of the media content to produce second recorded media content in response to receiving the record command. At 708, the method 700 includes receiving a stop recording command at the digital video recorder device from the remote control device. In response to receiving the stop recording command, the method 700 includes, at 710, stopping the recording of the media content, and, at 712, storing the second recorded media content at a memory (e.g., the memory 130) of the digital video recorder device.

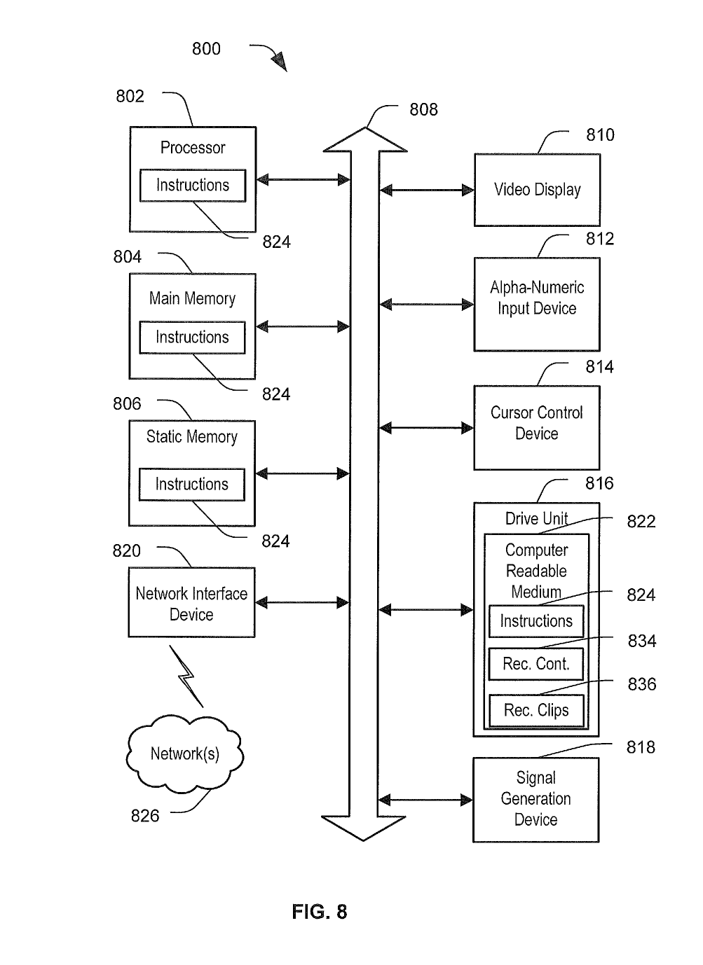

Referring to FIG. 8, an illustrative embodiment of a computer system is shown and designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices. For example, the computer system 800 or portions thereof may implement, include, or be included within any one or more of the devices illustrated in FIGS. 1-4, 6.

In a networked deployment, the computer system 800 may operate in the capacity of a server or as a client user computer in a server-client user network environment, or as a peer computer system in a distributed peer-to-peer or network environment. The computer system 800 can also be implemented as or incorporated into various devices, such as a set top box device (STB), a digital video recorder (DVR) device, a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, or a solid state display. Additionally, the computer system 800 may include an input device 812, such as a keyboard, and a cursor control device 814, such as a mouse. Such input devices may enable interaction with various GUIs and GUI controls. The computer system 800 can also include a disk drive unit 816, a signal generation device 818, such as a speaker or remote control, and a network interface device 820. In a particular embodiment, the memory 130 described with reference to FIG. 1, and/or the memories 630, 660 described with reference to FIG. 6 may include the main memory 804, the static memory 806, the disk drive unit 816, or a combination thereof.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein, such as the methods described with reference to FIGS. 1-7. For example, the instructions 824 may include instructions to generate a recording of a clip during playback of recorded content or instructions to generate an electronic program guide (e.g., the electronic program guide 500). In a particular embodiment, the instructions 824 may reside completely, or at least partially, within the main memory 804, the static memory 806, and/or within the processor 802 during execution by the computer system 800. The main memory 804 and the processor 802 also may include computer-readable media. Additionally, the computer-readable medium may store media content, such as recorded content 834 and recorded clips 836. In a particular embodiment, the recorded content 834 may be the recorded content 134 described with reference to FIG. 1 or may be the recorded content 210, 310, 410 described with reference to FIGS. 2-4. The recorded clips 836 may be the recorded clips 136 described with reference to FIG. 1 or may be the recorded clips 220, 320, 420, 440 described with reference to FIGS. 2-4. In an illustrative embodiment, the recorded content 834 may represent recordings of media content and clips stored at the memories 630, 660 described with reference to FIG. 6, or may represent recordings stored at the network digital video recorder devices 672, 692 described with reference to FIG. 6.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any non-transitory medium that is capable of storing or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device. Accordingly, the disclosure is considered to include any one or more of a computer-readable medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for communication include TCP/IP, UDP/IP, HTML, HTTP, CDMA, TDMA, FDMA, OFDMA, SC-FDMA, GSM, EDGE, evolved EDGE, UMTS, Wi-Max, GPRS, 3GPP, 3GPP2, 4G, LTE, high speed packet access (HSPA), HSPA+, and 802.11x. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A method comprising:
initiating playback of recorded media content at a digital video recorder device, wherein playback of the recorded media content includes displaying the recorded media content at a display device coupled to the digital video recorder device; and
during playback of the recorded media content:
receiving a record command from a remote control device at the digital video recorder device;
in response to receiving the record command, recording a portion of the recorded media content to produce second recorded media content;
receiving a stop recording command at the digital video recorder device;
in response to receiving the stop recording command, stopping the recording of the portion of the recorded media content, wherein the playback of the recorded media content continues after the stop recording command is received; and
storing the second recorded media content at a memory of the digital video recorder device.

2. The method of claim 1, further comprising:
initiating display of an electronic programming guide at the display device, wherein the electronic programming guide includes a selectable option to display a clips menu; and
in response to a selection of the option to display the clips menu, presenting a list of media content clips, the list of media content clips including an identifier of the second recorded media content, wherein the list of media content clips is determined based on metadata associated with each media content clip included in the list of media content clips.

3. The method of claim 1, wherein the record command and the stop recording command are received at a remote control interface device of the digital video recorder device.

4. The method of claim 1, wherein the record command is received at a first time during the playback of the recorded media content, wherein the stop recording command is received at a second time during the playback of the recorded media content, and wherein the second recorded media content corresponds to a portion of the recorded media content displayed at the display device between the first time and the second time.

5. The method of claim 4, wherein the second recorded media content does not include a first portion of the recorded media content that was displayed at the display device prior to the first time and wherein the second recorded media content does not include a second portion of the recorded media content that was displayed at the display device after to the second time.

6. The method of claim 2, wherein the record command is received at the digital video recorder device in response to a first selection of a record button on the remote control device at a first time during playback of the recorded media content and wherein the stop recording command is received at the digital video recorder device in response to a second selection of the record button at a second time during playback of the recorded media content.

7. The method of claim 1, further comprising stopping playback of the recorded media content.

8. The method of claim 1, further comprising deleting the recorded media content from the memory subsequent to storing the second recorded media content, wherein, subsequent to deleting the recorded media content, a portion of the memory where the recorded media content was stored may be used to store additional recorded media content.

9. The method of claim 1, further comprising:
receiving a request to name the second recorded media content;
receiving information indicating a name to be associated with the second recorded media content; and
associating the name with the second recorded media content.

10. The method of claim 9, wherein the information is received via a user interface presented at the display device.

11. The method of claim 1, further comprising:
receiving a request to playback the second recorded media content; and
in response to receiving the request, initiating playback of the second recorded media content.

12. A system comprising:
a processor; and
a memory storing instructions that, when executed by the processor, cause the processor to perform operations comprising:
initiating playback of recorded media content at an electronic device, wherein playback of the recorded media content includes displaying the recorded media content at a display accessible to the electronic device; and
during playback of the recorded media content:
receiving a record command from a remote control device at the electronic device;
in response to receiving the record command, initiating recording a portion of the recorded media content to produce second recorded media content;
receiving a stop recording command at the electronic device;
in response to receiving the stop recording command, stopping the recording of the recorded media content, wherein the playback of the recorded media content continues after the stop recording command is received, wherein the second recorded media content is stored at a memory within, or accessible to, the electronic device.

13. The system of claim 12, wherein the record command is received at the electronic device in response to a first selection of a record button on the remote control device at a first time during playback of the recorded media content, wherein the stop recording command is received at the digital video recorder device in response to a second selection of the record button at a second time during playback of the recorded media content.

14. The system of claim 13, wherein the record command is received at a first time during the playback of the recorded media content, wherein the stop recording command is received at a second time during playback of the recorded media content, and wherein the second recorded media content corresponds to a portion of the recorded media content displayed at the display device between the first time and the second time.

15. The system of claim 13, wherein the second recorded media content does not include a first portion of the recorded media content that was displayed at the display device prior to receiving the record command.

16. The system of claim 12, wherein the record command and the stop recording command are received at a remote control interface device of the electronic device.

17. A computer-readable storage medium comprising instructions that, when executed by a processor, cause the processor to perform a method, the method comprising:
initiating playback of recorded media content at an electronic device, wherein playback of the recorded media content includes displaying the recorded media content at a display device and
during playback of the recorded media content:
receiving a record command at the electronic device;
in response to receiving the record command, initiating a recording of a portion of the recorded media content to produce second recorded media content;
receiving a stop recording command at the electronic device; and
in response to receiving the stop recording command, stopping the recording of the recorded media content, wherein the playback of the recorded media content continues after the stop recording command is received, and wherein the second recorded media content is stored at a memory accessible to the electronic device.

18. The computer-readable storage medium of claim 17, wherein the record command is received at a first time during the playback of the recorded media content, wherein the stop recording command is received at a second time during playback of the recorded media content, wherein the second recorded media content corresponds to a portion of the recorded media content displayed at the display device between the first time and the second time, wherein the record command is received at the electronic device in response to a first selection of a record button during playback of the recorded media content, and wherein the stop recording command is received at the electronic device in response to a second selection of the record button during playback of the recorded media content.

19. The computer-readable storage medium of claim 18, wherein the electronic device is one of a set top box device and a portable electronic device, wherein the memory is within a network digital video recorder device accessible to the electronic device via a network, and wherein initiating the recording of the portion of the media content to produce the second recorded media content comprises transmitting the record command from the electronic device to the network digital video recorder device via the network.

20. The computer-readable storage medium of claim 18, wherein the electronic device is a set top box device.
